(19) United States
(12) Patent Application Publication
(10) Pub. No.: US 2019/0119091 A1
(43) Pub. Date: Apr. 25, 2019

(54) A BEVERAGE FONT ASSEMBLY FOR BEING MOUNTED ON A BAR COUNTER OF A DRINKING ESTABLISHMENT AND A METHOD OF MONITORING A BEVERAGE FONT ASSEMBLY MOUNTED ON A BAR COUNTER IN A DRINKING ESTABLISHMENT

(71) Applicant: CARLSBERG BREWERIES A/S, Copenhagen V (DK)

(72) Inventor: Nikolaj Heiberg Bestle, Copenhagen O (DK)

(73) Assignee: CARLSBERG BREWERIES A/S, Copenhagen V (DK)

(21) Appl. No.: 16/091,070

(22) PCT Filed: Apr. 11, 2017
(86) PCT No.: PCT/EP2017/058594

§ 371 Date: Oct. 3, 2018

(30) Foreign Application Priority Data
Apr. 18, 2016 (EP) 16165703.6

(51) Int. Cl. B67D 1/08; B67D 1/06

(52) U.S. Cl. CPC B67D 1/0877; B67D 1/0888; B67D 1/06

(57) ABSTRACT

The present invention relates to a beverage font assembly (10) for a drinking establishment. The beverage font assembly (10) comprises a beverage font (16) mounted on a bar counter (24) having a customer side and an operator side. The beverage font includes a tapping head (17) having a spout (18) and a handle (20). The beverage font (16) is connectable to a tapping line extending to a beverage container. The handle (20) is operable between a non-beverage dispensing position and a beverage dispensing position. In the non-beverage dispensing position, the beverage may not flow from the container to the spout (18). In the beverage dispensing position, the beverage may flow from the container to the spout (18). The beverage font assembly further comprises a projection screen (14) mounted on the beverage font. The projection screen (14) is visible from the customer side of the beverage font. The beverage font assembly further comprises a video projector (12) for projecting an image onto the projection screen (14).

The present invention relates to a beverage font assembly for being mounted on a bar counter of a drinking establishment and a method of monitoring a beverage font assembly mounted on a bar counter in a drinking establishment.

### BACKGROUND

A draught beverage is served to the customer from a large pressurized beverage container, known as a keg, into a beverage glass by an operator using a draught beverage system. The draught beverage system comprises, apart from the beverage container and associated pressurization system, a beverage font. The beverage font, also known as a tapping stanchion, tapping column or tapping rod due to its typically elongated shape, receives the beverage via a tapping line connected to the container and comprises a faucet for controlling the flow of beverage from the container. The faucet comprises a valve, a handle and a spout. Although draught beverages typically refer to beer, it is understood that other beverage may be used, both alcoholic and non-alcoholic, carbonated and non-carbonated.

Draught beverages are typically served in professional drinking establishments such as bars, pubs, cafès, canteens, restaurants etc., although there exist small and mobile draught systems which are also suitable for private use. In professional drinking establishments, the beverages are served to the customers by an operator standing on one side of a bar counter while the customer remains on the other side of the bar counter. The beverage font is typically mounted on the bar counter visible to the customer and the process of filling the glass with the draught beverage is normally performed in full view of the customer. The beverage font is typically marked with advertisements, typically relating to the brand and type of beverage served.

The advertisements on the beverage fonts are typically fixed images which may occasionally be lit up by internal lighting. Moving or changing images by means of video screen such as LCD displays or vacuum tubes have been avoided due to the concern of electric shock and fire when placing high voltage electronic devices in the immediate proximity of operators and customers handling water based beverages and alcohol in an often congested and stressful environment. Further, LCD displays and the like, although being quite slender and light, can appear quite bulky when mounted on or at the font. Yet further, LCD displays and vacuum tubes usually provide a disturbing sharp and/or blue light in dimmed locations such as bars and pubs.

There exist some prior art which disclose beverage fonts that include provisions for allowing light effects and even images in connection with beverage fonts:

US 2011/216525 (A1) discloses an enhanced beer tap handle whereby an illumination mechanism is coupled to an existing beer tap handle in order to draw attention to the beer tap handle. The beer tap handle includes a beer tap and an illumination mechanism coupled to the beer tap. The illumination mechanism is a separate piece that is coupled to the beer tap on top of the clamping nut via the stud. The handle portion is then coupled to the stud thereby locking the illumination mechanism into place. However, there is no provision for displaying images or video.

U.S. Pat. No. 5,586,691 (A) discloses a combination of a dispense tap and a customer information display. The dispense tap handle is formed of or includes light transparent and/or light reflective material. A light generating means is attached to the tap body, or a counter fitting therefor, remotely from the tap handle. Means are provided to direct light from the light generating means to the tap handle, whereby, in use, the tap handle can illuminate to display customer information. However, there is no provision for displaying images or video.

US 2005/047143(A1) discloses a single light illumination system for a fluid tap. The single light, in the form of a single or multi-color light emitting diode, is insertion injection molded into a tap in position to illuminate the lower surfaces of a beer dispenser upon which the tap is mounted. Means for sensing fluid flow, temperature, and pressure, are within the tap for the purpose of illuminating alarm indicating LEDs displayed on the tap. Separate electrical circuits, with externally accessible electrical jumpers for programming different modes of controlled illumination, are provided for a single color LED, and for a multi-color LED. However, there is no provision for displaying images or video.

US 2006/226250 (A1) discloses a light projecting beverage dispensing device. A beverage dispensing assemblage or device is provided which includes light emitting means adapted to project light upward so as to highlight a selected portion of the ceiling or other features located above the device. The beam can project unencumbered light or words or images comprising customer information. It allows for simple inexpensive and rapid changes in the message projected. However, the customer's attention is normally not directed to the ceiling but straight forward.

The object according to the present invention is thus to provide video images at or adjacent the beverage font without any of the above mentioned drawbacks.

### SUMMARY OF THE INVENTION

The above object is according to the teachings of the present invention achieved in a first aspect of the present invention by a beverage font assembly for a drinking establishment, the beverage font assembly comprising:
a beverage font for being mounted on a bar counter and defining an operator side and a customer side opposite the operator side, the beverage font including a tapping head facing the operator side, the tapping head having a spout and a handle and being connectable to a tapping line extending through the beverage font to a beverage container which includes a beverage, the handle being operable between a non-beverage dispensing position, in which the beverage is prevented to flow from the container via the tapping line and the tapping head to the spout and a beverage dispensing position, in which the beverage may flow from the container via the tapping line and the tapping head to the spout,
a projection screen being mounted on the beverage font, the projection screen being visible from the customer side of the beverage font, and
a video projector for projecting an image onto the projection screen.

Beverage fonts are typically placed in central locations in drinking establishments and are typically eye catching installations. They are therefore often used for distributing commercial messages such as company and brand logotypes etc. It would be an advantage to be able to use this exposed location in the drinking establishment for providing video images, in particular moving images. In order to avoid sensitive and potentially hazardous electronic devices in the vicinity of operators and customers, it is suggested to instead place a projection screen on the beverage font and locate a video projector at a distant and safe location. In this way, there is no risk of electric shock or fire close to the operators and users. Further, there is no risk of damaging the electronic equipment by accidentally spilling water or alcohol on them. Yet further, a projection screen may be made very thin and light relative to its area, much thinner and lighter than even the most compact LCD device of similar area.

Previously, video projectors were relatively large and loud and as such not suitable for use in drinking establishments. Nowadays, however, there exist pocket video projectors which are very compact and silent. The drawback is, however, that the light intensity is quite low and they are consequently not entirely suitable in very bright locations. However, drinking establishments are typically quite dimmed and thus the images which the video projectors project on the projection screen are much less intense than the light from LCD and vacuum tubes. The projected image will thus appear much more appealing to the customer than a corresponding LCD displayed image.

The handle of the beverage font is typically in the upright position which constitutes the non-beverage dispensing position. When beverage is about to be dispensed, the operator puts a beverage glass under the spout and swings the handle from the upright position, which constitutes the non-beverage dispensing position, to a horizontal position, which constitutes the beverage dispensing position, allowing the valve to open and beverage to flow from the container to the spout and out through the spout. The container may be both a classic steel container or a modern collapsible polymeric container.

According to a further embodiment of the first aspect, the projection screen is mounted on the handle and the projection screen being visible from the customer side of the beverage font when the handle is in the non-beverage dispensing position.

In a particular advantageous embodiment, the projection screen is mounted on the handle. The handle is a central part of the beverage font and as such a location which will attract the attention of the customer. When the handle is in the non-beverage dispensing position, the projection screen and consequently the image projected on it should be visible to the customer. As the operator swings the handle in order to allow beverage dispensing, the projection screen will follow the handle and assume a horizontal position, which thus prevents a correct projection of any images on the projection screen during the beverage dispensing. The projector may then be temporarily turned off or obscured or alternatively redirected to project an image on an alternative projection screen for the duration of the beverage dispensing.

According to a further embodiment of the first aspect, the projection screen is integrated in the beverage font, mounted adjacent the handle, mounted between the handle and the user side of the beverage font.

Alternatively, the projection screen is fixed on the beverage font in order to be permanently visible for the customer. The projection screen may e.g. be mounted on the tapping head. Locations between the handle and the user side or adjacent the handle have the benefit of being close to the customer's attention. The projection screen may even be integrated in the beverage font, e.g. made part of the beverage font.

According to a further embodiment of the first aspect, the projection screen is transmissive or reflective.

Reflective projection screens are viewed from the front, i.e. the same side as the video projector, whereas transmissive projection screens are viewed from the rear, i.e. the opposite side of the video projector. Both types of projection screens are feasible.

According to a further embodiment of the first aspect, the video projector is positioned in a dust- and waterproof location within the beverage font or below the beverage font.

The video projection can be mounted in a dust and waterproof location. One way is to enclose the video projector in a dust- and waterproof housing; however, video projectors, even pocket sized, need cooling which would have to be arranged through the dust- and watertight housing. A preferred location for the video projection would be inside the beverage font. The location inside the beverage font may be made both dust- and watertight since it is not normally accessible from the outside. Moreover, cooling of the projector may be arranged by ventilators or it may even be considered to use the same cooling system as used for keeping the beverage cool.

According to a further embodiment of the first aspect, the beverage font including a light guide such as one or more mirrors, prisms, lenses, light pipes or optical fibers.

In order to be able to position the projector offset in relation to the projection screen, i.e. not having the projector in line with the screen, one or more mirrors, prisms, lenses, light pipes or optical fibers may be used to deflect and divert the beam of light from the projector towards the protecting screen. In this way, the projector may be located in an even more protected location distant from the spout, handle, projection screen, operators and customers.

According to a further embodiment of the first aspect, the light guide is adjustable such that the video projector may project an image onto a secondary projection screen, e.g. when the handle is in the beverage dispensing position.

A secondary projection screen may optionally be used, in particular as mentioned above together with a primary projection screen mounted on a handle for continuing to project an image when the primary projection screen is in the horizontal position. It may also be feasible to alter the projection of the image from the video projector between two fixed projection screens.

According to a further embodiment of the first aspect, the video projector may be located outside the beverage font in a dust- and waterproof location within the drinking establishment at the customer side or at the operator side, such as connected to the ceiling of the drinking establishment.

The video projector may e.g. be mounted in the ceiling, either at the customer side using a reflective projection screen, or at the operator side using a transmissive projection screen. In this way, the projector is unreachable for unintentional contact with the operators and customers. Other concealed locations are of course feasible using light guides such as optical fibers.

According to a further embodiment of the first aspect, the video projector is located between 1 cm and 500 cm from the projection screen, preferably between 5 cm and 50 cm.

Pocket video projectors do not have a great light intensity and thus the video projector should not be positioned too far from the projection screen. Further, the screens which are used together with the beverage fonts have a limited area compared to screens used in auditoriums, cinemas, offices etc. Thus, the above mentioned distances are suitable.

According to a further embodiment of the first aspect, the video projector is controlled by wire or by wireless technologies.

The video projection is typically controlled by a computer for generating the images and videos to be presented on the projection screen. The video data may be transferred to the video projector by wire, e.g. using digital technologies such as Ethernet, HDMI or DVI, analogue technologies such as RGB, S-video or composite video, or wireless technologies such as WiFi or 4G. In this way, the computer or device rendering the images and videos may be located at a distant location.

According to a further embodiment of the first aspect, the video projector may be controllable by a customer and/or an operator.

The operator or even the customers may optionally be allowed to influence the content of the images projected onto the projection screen. For instance, the customers may be able to access a computer terminal or connect their smartphones via WiFi or Bluetooth technologies for uploading pictures and/or otherwise manipulate the content of the projected images and videos, possibly via an app.

According to a further embodiment of the first aspect, the video projector is having internet access.

Preferably, for the purpose of customer interaction, the video projector is directly or indirectly connected to the internet. In this way, customer interaction is greatly simplified and allows interaction by operators and/or customers who are not even present in the drinking establishment.

According to a further embodiment of the first aspect, the video projector is controlled by the handle.

The handle may be linked to the control of the video projector such that the video projector is turned off or displays a different image or video when the handle is swung into the horizontal position.

The above object is according to the teachings of the present invention achieved in a second aspect of the present invention by a method of assembling a beverage font assembly in a drinking establishment, the method comprising the steps of:
mounting a beverage font on a bar counter of the drinking establishment, the beverage font defining an operator side and a customer side opposite the operator side, the beverage font including a tapping head facing the operator side, the tapping head having a spout and a handle and being connectable to a tapping line extending through the beverage font to a beverage container which includes a beverage, the handle being operable between a non-beverage dispensing position, in which the beverage is prevented to flow from the container via the tapping line and the tapping head to the spout and a beverage dispensing position, in which the beverage may flow from the container via the tapping line and the tapping head to the spout,
mounting a projection screen on the beverage font, the projection screen being visible from the customer side of the beverage font, and
mounting a video projector in the drinking establishment for projecting an image onto the projection screen.

The above method according to the second aspect is preferably used together with the above assembly according to the first aspect.

According to a further embodiment of the second aspect, the beverage font assembly is according to any of the beverage fonts described in connection with the first aspect.

### BRIEF DESCRIPTION OF THE DRAWINGS

FIG. 1 is a beverage font assembly including a video projector and a projection screen.

FIG. 2A is a beverage font assembly with a mirror.

FIG. 2B is a beverage font assembly with a mirror and a projection screen on the font.

FIG. 2C is a beverage font assembly having an integrated screen on the font.

FIG. 3A is a beverage font assembly with a projection screen on the handle.

FIG. 3B is a beverage font assembly with a light tube and a projection screen.

FIG. 3C is a beverage font assembly having a video projector mounted in the ceiling.

FIG. 3D is a beverage font assembly having a video projector behind the screen.

FIG. 4A is a beverage font assembly having a movable mirror when non-dispensing.

FIG. 4B is a beverage font assembly having a movable mirror when dispensing.

FIG. 5A is a beverage font assembly having a second screen when non-dispensing.

FIG. 5B is a beverage font assembly having a second screen when dispensing.

### DETAILED DESCRIPTION OF THE DRAWINGS

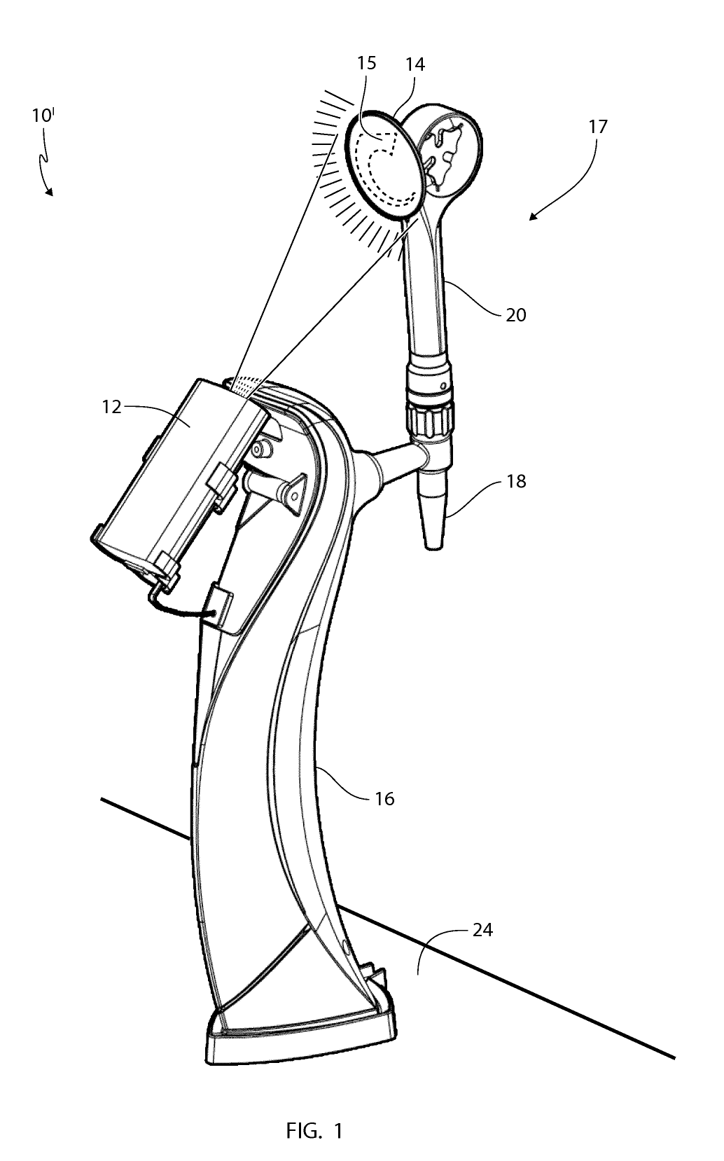

FIG. 1 shows a perspective view of a beverage font assembly 10′ including a video projector 12 and a projection screen 14. An image 15, preferably being a video having a commercial message, is projected on the projection screen 14. The beverage font assembly is for use with a beverage dispensing system including pressurized beverage containers (not shown) and comprises a font 16, which is to be mounted on a bar counter (not shown) of a drinking establishment (not shown). The font 16 is also known as column, stanchion, rod etc. due to its upright position. The font 16 is typically located at a central location within the drinking establishment to catch the eyes of the customer. The projecting screen 14 is visible to the customer and not necessarily visible to the beverage dispensing system operator. Drinking establishment is here to be understood as encompassing mainly commercial establishments such as bars, pubs, cafès, canteens, restaurants, etc., however, it may occasionally also include private homes etc.

The font 16 comprises a tapping head 17 having a spout 18 under which the operator would hold a beverage glass (not shown) during dispensing. The spout 18 is connected via a valve (not shown) and a tapping line (not shown) which are both within the font 16 to a pressurized beverage container which may be located below the bar counter or even in the cellar. The tapping head 17 of the font 16 further comprises a handle 20 which is controlling the valve (not shown). The handle 20 may assume a non-beverage dispensing position (the presently shown position), in which the handle is substantially upright and the valve (not shown) remains closed, and a beverage dispensing position, in which the handle 20 is swung into a substantially horizontal or at least non-upright position and the valve (not shown) opens to allow beverage (not shown) to flow from the pressurized beverage container (not shown) to the beverage glass held below the spout 18.

The video projector 12 is mounted on the font 16 in a substantially dust- and water-proof housing. The video projector may be of the pocket video projector type which is typically used in private homes and smaller conference rooms for various kinds of video presentations. The handle 20 comprises a projection screen of the reflective type for receiving an image from the video projector 12. The image may be a still image or a moving animation or video. The video projector 12 and the projection screen 14 should be mounted such that the image from the video projector 12 is correctly projected onto the projection screen 14 when the handle is in the upright non-beverage dispensing position. The light intensity of the projector should be adapted to the ambient light in the drinking establishment. Various font designs exist, such as straight fonts and curved fonts, and the font may also include two or more spouts and handles, each of which may have an associated video projector and projection screen. The projection screen may be a simple white or plate made of plastic, polyester, fabric or similar material allowing a clear projected image to appear.

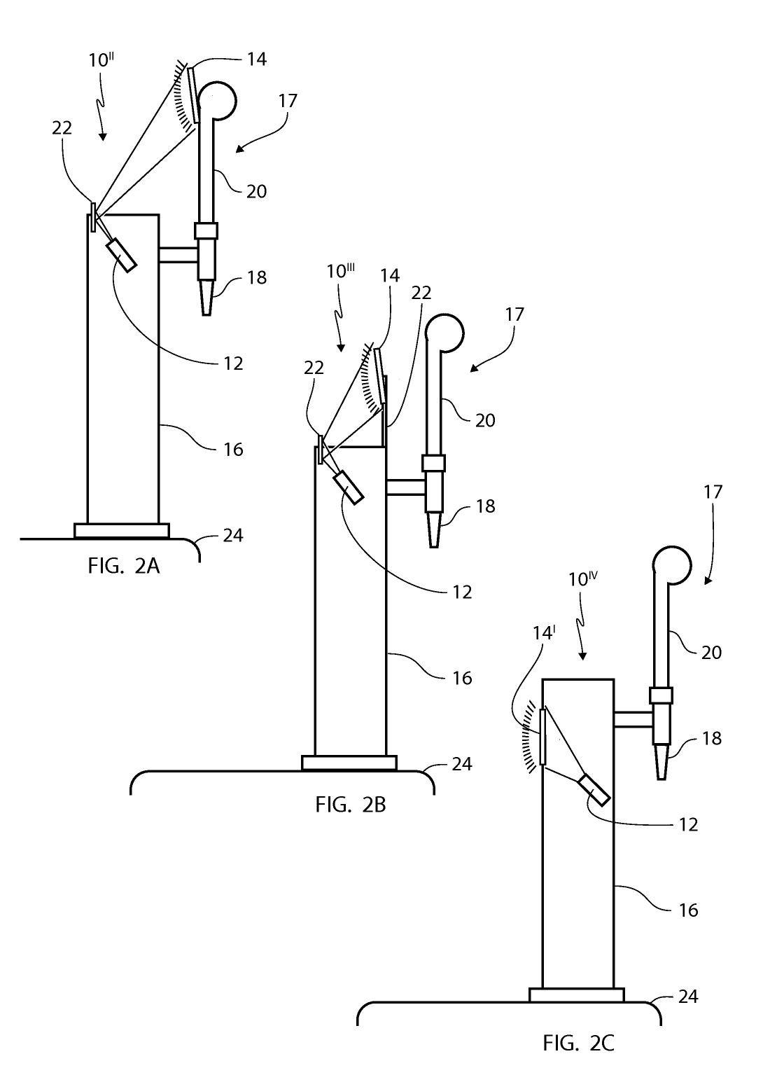

FIG. 2A shows a side view of a beverage font assembly 10^{II} with a mirror 22. In this way, the video projector 12 may be located within the font 16 and protected from dust and liquids. The video projector 12 may e.g. be located under a transparent cover. The video projector 12 may be cooled via the beverage cooling system (not shown) which is typically constituted by a cooling hose (not shown) inside the font or alternatively via a separate fan (not shown). The video projector 12 thus projects an image onto the mirror 22, which is reflected onto the projection screen 14. Further, it is evident that the mirror 22 may be replaced by similar optical devices such as prisms. The present font 16 is mounted on a bar counter 24.

FIG. 2B shows a side view of a beverage font assembly 10^{III} with a mirror 22 and a projection screen 14 mounted on the font 16 instead of on the handle 20. The projection screen 14 may e.g. be mounted on a holder 26 which is in turn mounted on the font 16 either in front of the handle 20 or beside the handle 20. In this way, the image remains visible when the handle 20 is swung away from the upright position, i.e. to the dispensing position.

FIG. 2C shows a beverage font assembly 10^{IV} having an integrated screen 14′ on the font 16. The video projector 12 is located within the font 16 and the projection screen 14′ is of the transmissive type and thus the video projector 12 is illuminating the projection screen 14′ from behind. There is thus no risk for any interference of the light beam between the video projector 12 and the projecting screen 14.

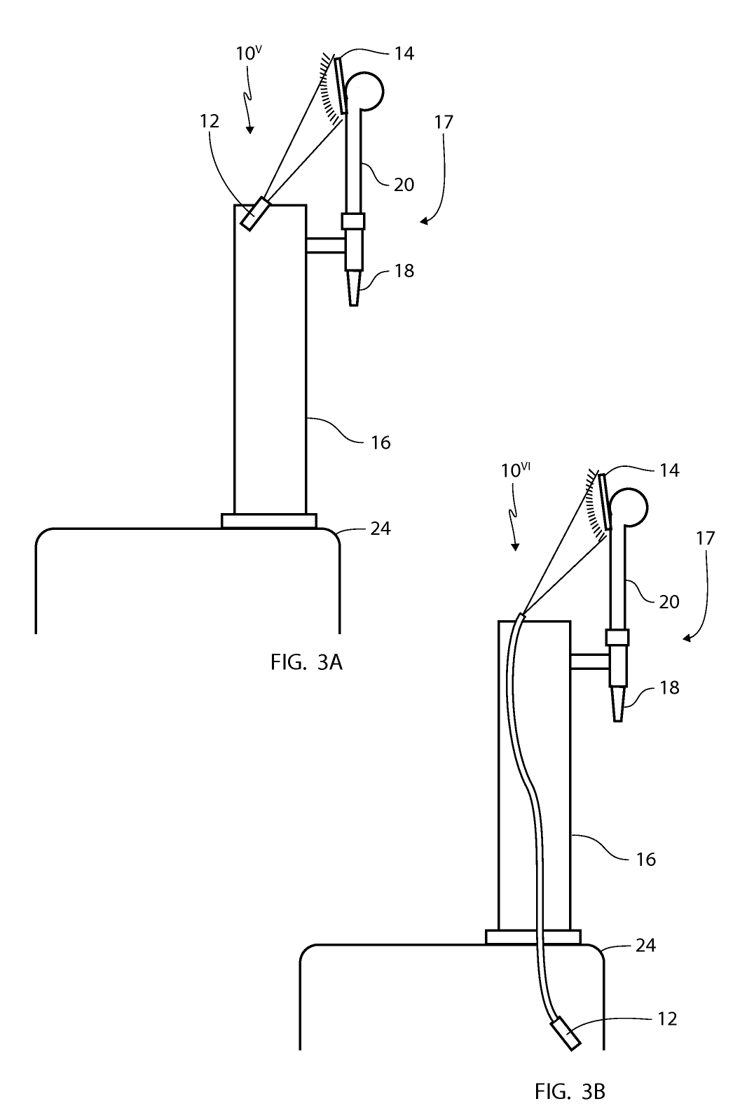

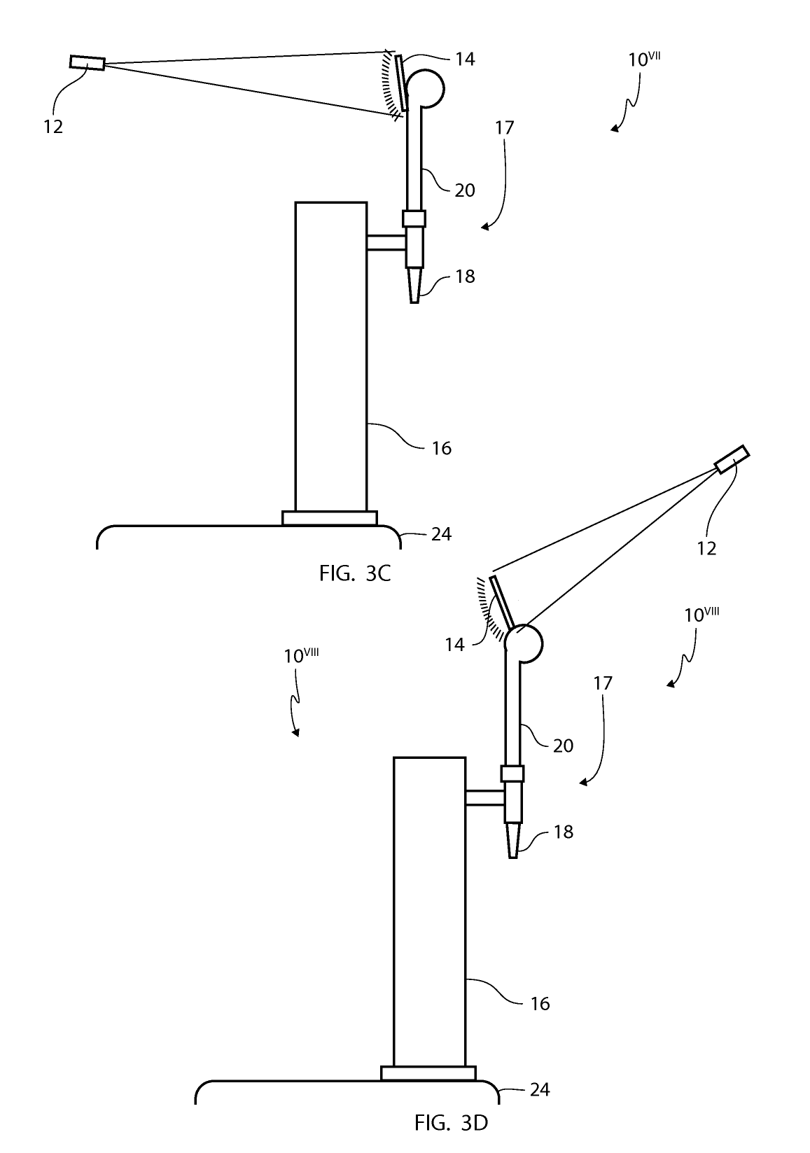

FIG. 3A shows a beverage font assembly 10^{v} with a projection screen 14 on the handle 20 similar to the embodiment shown in FIG. 1. The video projector 12 is located within the font 16 and illuminates the projection screen 14 directly.

FIG. 3B is a beverage font assembly 10^{VI} with a light tube 28 and a projection screen 14 on the font 16. The video projector 12 is in the present embodiment located within the bar counter 24. The light beam from the video projector 12 is led via the light tube 28 to the top of the font 16 to project the image onto the projection screen 14. The light tube 28 may be replaced by other suitable light guides such as one or more optical fibres.

FIG. 3C shows a beverage font assembly 10^{VII} having a video projector 12 mounted in the ceiling or adjacent the ceiling of the drinking establishment. A position adjacent the ceiling avoids the risk of spillage of beverage into the video projector 12.

FIG. 3D shows a beverage font assembly 10^{VIII} having a video projector 12 behind the projection screen 14. The present embodiment is similar to the embodiment shown in connection with FIG. 3C except that the video projector 12 is located in the ceiling or adjacent the ceiling of the drinking establishment behind the projection screen instead of in front of the projection screen 14 and that the projection screen 14 is transmissive instead of reflective.

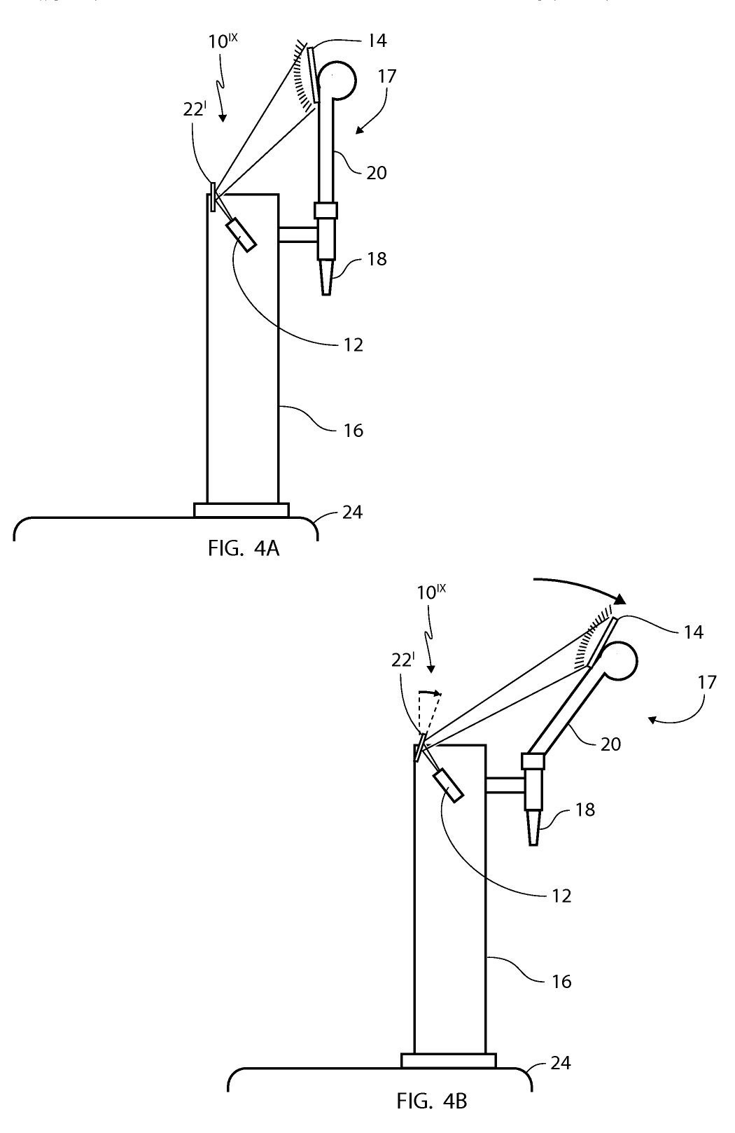

FIG. 4A is a beverage font assembly 10^{1X} having a movable mirror 22′ when non-dispensing. When the beverage dispensing system is in the non-beverage dispensing position, i.e. the handle 20 is upright, the mirror 22′ is as well upright and redirects the beam from the video projector 12 inside the font 16 to project an image onto the projection screen 14.

FIG. 4B is a beverage font assembly 10^{IX} having a movable mirror 22′ when dispensing. When the beverage dispensing system is in the beverage dispensing position, i.e. the handle 20 is swung into the non-upright position, the mirror 22′ is as well swung into a tilted position in order to redirect the beam from the video projector 12 inside the font 16 to project an image onto the projection screen 14 which is now tilted along with the handle 14. When the handle 20 is returned to the upright position, the mirror 22′ is tilted back to its original angle along with the projection screen 14 and the video projector 12 again projects the image on the upright projection screen 14.

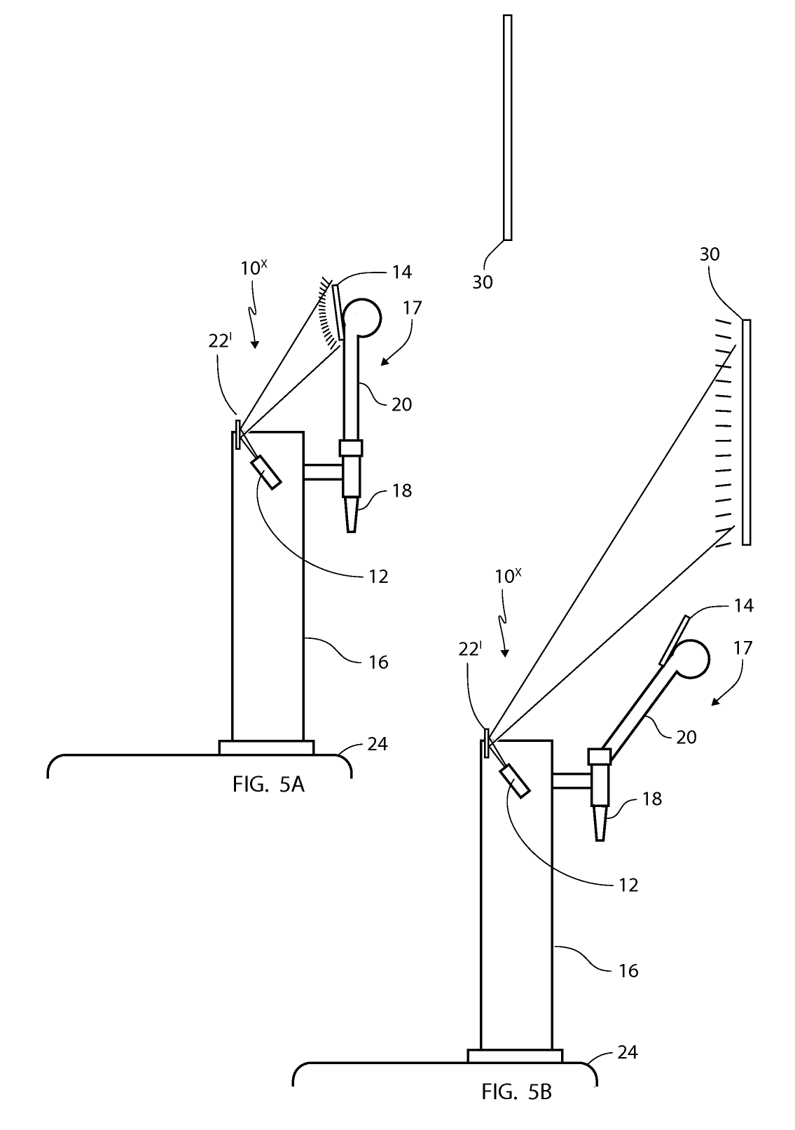

FIG. 5A is a beverage font assembly 10^{x} having a second screen 30 when non-dispensing. When the beverage dispensing system is in the non-beverage dispensing position, i.e. the handle 20 is upright, the video projector 12 is projecting an image on the projecting screen 14 which is mounted on the handle 20. The second projecting screen 30 which is located behind the projecting screen 14 is thus not illuminated.

FIG. 5B is a beverage font assembly 10^{X} having a second screen when dispensing. When the beverage dispensing system is in the beverage dispensing position, i.e. the handle 20 is swung into the non-upright position, the projection screen 14 is swung along with the handle 20 and tilted out of the way of the projection beam from the video projector 12. The beam from the video projector 12 thus instead projects a larger image on the second projection screen 30 located behind the projection screen 14. When the handle 20 is returned to the upright position, the video projector 12 again projects the image on the projection screen 14.

The above described embodiments describe specific realizations according to the present invention showing specific features; however, it is apparent to the skillful individual that the above described embodiments may be modified, combined or aggregated to form numerous further embodiments.

### REFERENCE NUMERALS

10. Beverage dispensing assembly

12. Video projector

14. Projection screen

15. Image

16. Font

17. Tapping head

18. Spout

20. Handle

22. Mirror

24. Bar counter

26. Holder

28. Light pipe

30. Second projection screen

1-15. (canceled)

16. A beverage font assembly for a drinking establishment, said beverage font assembly comprising:
a beverage font mountable on a bar counter and defining an operator side and a customer side opposite the operator side, the beverage font including a tapping head facing the operator side, the tapping head having a spout and a handle and being connectable to a tapping line extending through the beverage font to a beverage container which includes a beverage, the handle being operable between a non-beverage dispensing position, in which the beverage is prevented from flowing from the beverage container via the tapping line and the tapping head to the spout, and a beverage dispensing position, in which the beverage may flow from the container via the tapping line and the tapping head to the spout;
a projection screen mounted on the beverage font so as to be visible from the customer side of the beverage font when the beverage font is mounted on a bar counter; and
a video projector mounted on the beverage font and configured for projecting an image onto the projection screen.

17. The beverage font assembly according to claim 16, wherein the projection screen is mounted on the handle and is visible from the customer side of the beverage font when the handle is in the non-beverage dispensing position.

18. The beverage font assembly according to claim 16, wherein the projection screen is mounted adjacent the handle.

19. The beverage font assembly according to claim 16, wherein the projection screen is mounted between the handle and the user side of the beverage font.

20. The beverage font assembly according to claim 16, wherein the projection screen is transmissive of light.

21. The beverage font assembly of claim 16, wherein the projection screen is reflective of light.

22. The beverage font assembly according to claim 16, wherein the video projector is positioned in a dust-proof and waterproof location within the beverage font.

23. The beverage font assembly according to claim 16, wherein the video projector is positioned in a dust-proof and waterproof location outside the beverage font.

24. The beverage font assembly according to claim 16, wherein the beverage font includes a light guide.

25. The beverage font assembly according to claim 24, wherein the light guide is selected from the group consisting of one or more of mirrors, prisms, lenses, light pipes, and optical fibers.

26. The beverage font assembly according to claim 24, further comprising a secondary projection screen, wherein the light guide is adjustable such that the video projector is operable to project an image onto the secondary projection screen when the handle is in the beverage dispensing position.

27. The beverage font assembly according to claim 23, wherein the dust-proof and waterproof location is below the beverage font.

30. The beverage font assembly according to claim 16, wherein the video projector is located between 1 cm and 500 cm from the projection screen.

31. The beverage font assembly according to claim 30, wherein the video projector is between 5 cm and 50 cm from the projection screen.

32. The beverage font assembly according to claim 16, wherein the video projector is controlled wirelessly.

33. The beverage font assembly according to claim 16, wherein the video projector is accessible via the Internet.

34. The beverage font assembly according to claim 16, wherein the video projector is controlled by the handle.

35. A method of assembling a beverage font assembly in a drinking establishment, said method comprising the steps of:
mounting a beverage font on a bar counter of the drinking establishment, the mounted beverage font defining an operator side and a customer side opposite the operator side, the beverage font including a tapping head facing the operator side, the tapping head having a spout and a handle, the beverage font being connectable to a tapping line extending through the beverage font to a beverage container which includes a beverage, the handle being operable between a non-beverage dispensing position, in which the beverage is prevented from flowing from the container via the tapping line and the tapping head to the spout, and a beverage dispensing position, in which the beverage is permitted to flow from the container via the tapping line and the tapping head to the spout;
mounting a projection screen on the beverage font so as to be visible from the customer side of the beverage font; and
locating a video projector in the drinking establishment for projecting an image onto the projection screen.
